(19) United States
(12) Patent Application Publication
(10) Pub. No.: US 2026/0088869 A1
(43) Pub. Date: Mar. 26, 2026

(54) TWO-STAGE PHYSICAL DOWNLINK CONTROL CHANNEL COMMUNICATIONS FOR TIME-DOMAIN CHANNEL STATE INFORMATION TRIGGERING

(71) Applicant: QUALCOMM Incorporated, San Diego, CA (US)

(72) Inventors: Jing DAI, Beijing (CN); Yu ZHANG, San Diego, CA (US); Lei XIAO, San Jose, CA (US)

(21) Appl. No.: 19/103,187

(22) PCT Filed: Nov. 4, 2022
(86) PCT No.: PCT/CN2022/129748

§ 371 Date: Feb. 11, 2025

(51) Int. Cl. H04B 7/06; H04L 5/00

(52) U.S. Cl. CPC H04B 7/0626; H04L 5/0044

(57) ABSTRACT

Various aspects of the present disclosure generally relate to wireless communication. In some aspects, a user equipment (UE) may receive a first physical downlink control channel (PDCCH) communication. The UE may receive a second PDCCH communication after receiving the first PDCCH communication. The UE may transmit, based at least in part on receiving the second PDCCH, time-domain channel state information (TD-CSI) feedback for one or more associated CSI reference signal (CSI-RS) occasions. Numerous other aspects are described.

### FIELD OF THE DISCLOSURE

Aspects of the present disclosure generally relate to wireless communication and to techniques and apparatuses for two-stage physical downlink control channel communications for time-domain channel state information triggering.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a first physical downlink control channel (PDCCH) communication. The method may include receiving a second PDCCH communication after receiving the first PDCCH communication. The method may include transmitting, based at least in part on receiving the second PDCCH, time-domain channel state information (TD-CSI) feedback for one or more associated CSI reference signal (CSI-RS) occasions.

Some aspects described herein relate to a method of wireless communication performed by a network node. The method may include transmitting a first PDCCH communication. The method may include transmitting a second PDCCH communication after transmitting the first PDCCH communication. The method may include receiving, based at least in part on the second PDCCH, TD-CSI feedback for one or more CSI-RS occasions.

Some aspects described herein relate to a UE for wireless communication. The UE may include a memory and one or more processors coupled to the memory. The one or more processors may be configured to receive a first PDCCH communication. The one or more processors may be configured to receive a second PDCCH communication after receiving the first PDCCH communication. The one or more processors may be configured to transmit, based at least in part on receiving the second PDCCH, TD-CSI feedback for one or more associated CSI-RS occasions.

Some aspects described herein relate to a network node for wireless communication. The network node may include a memory and one or more processors coupled to the memory. The one or more processors may be configured to transmit a first PDCCH communication. The one or more processors may be configured to transmit a second PDCCH communication after transmitting the first PDCCH communication. The one or more processors may be configured to receive, based at least in part on the second PDCCH, TD-CSI feedback for one or more CSI-RS occasions.

Some aspects described herein relate to a non-transitory computer-readable medium that stores a set of instructions for wireless communication by a UE. The set of instructions, when executed by one or more processors of the UE, may cause the UE to receive a first PDCCH communication. The set of instructions, when executed by one or more processors of the UE, may cause the UE to receive a second PDCCH communication after receiving the first PDCCH communication. The set of instructions, when executed by one or more processors of the UE, may cause the UE to transmit, based at least in part on receiving the second PDCCH, TD-CSI feedback for one or more associated CSI-RS occasions.

Some aspects described herein relate to a non-transitory computer-readable medium that stores a set of instructions for wireless communication by a network node. The set of instructions, when executed by one or more processors of the network node, may cause the network node to transmit a first PDCCH communication. The set of instructions, when executed by one or more processors of the network node, may cause the network node to transmit a second PDCCH communication after transmitting the first PDCCH communication. The set of instructions, when executed by one or more processors of the network node, may cause the network node to receive, based at least in part on the second PDCCH, TD-CSI feedback for one or more CSI-RS occasions.

Some aspects described herein relate to an apparatus for wireless communication. The apparatus may include means for receiving a first PDCCH communication. The apparatus may include means for receiving a second PDCCH communication after receiving the first PDCCH communication. The apparatus may include means for transmitting, based at least in part on receiving the second PDCCH, TD-CSI feedback for one or more associated CSI-RS occasions.

Some aspects described herein relate to an apparatus for wireless communication. The apparatus may include means for transmitting a first PDCCH communication. The apparatus may include means for transmitting a second PDCCH communication after transmitting the first PDCCH communication. The apparatus may include means for receiving, based at least in part on the second PDCCH, TD-CSI feedback for one or more CSI-RS occasions.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram of an example of precoding using a Type-II codebook, in accordance with the present disclosure.

FIG. 5 is a diagram of examples associated with time-domain channel state information, in accordance with the present disclosure.

FIG. 6 is a diagram of an example associated with two-stage physical downlink control channel communications for time-domain channel state information triggering, in accordance with the present disclosure.

FIG. 7 is a diagram of examples associated with two-stage physical downlink control channel communications for time-domain channel state information triggering, in accordance with the present disclosure.

FIG. 8 is a diagram of an example associated with two-stage physical downlink control channel communications for time-domain channel state information triggering, in accordance with the present disclosure.

FIG. 9 is a diagram of an example associated with two-stage physical downlink control channel communications for time-domain channel state information triggering, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

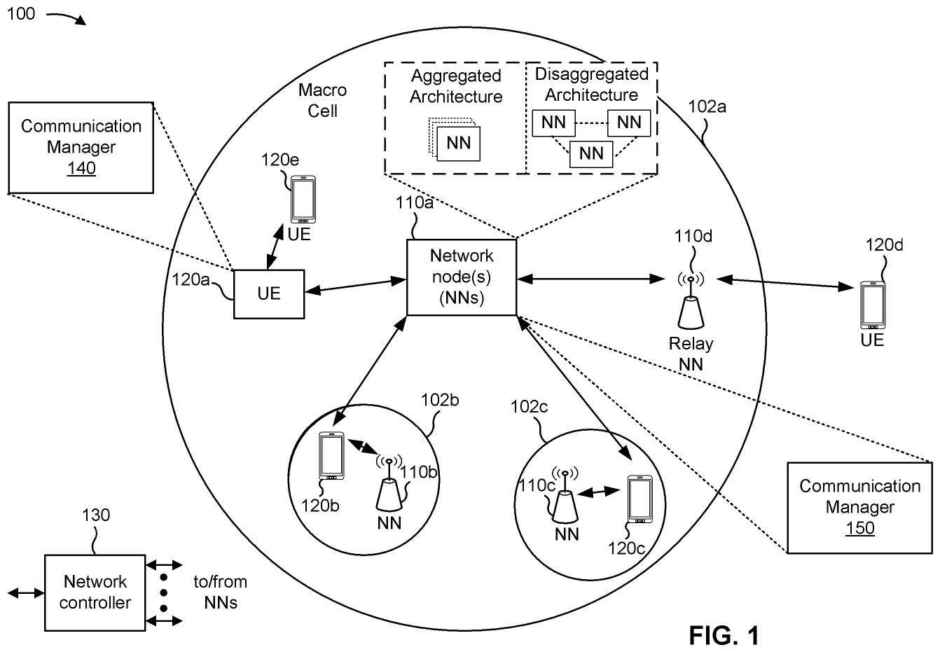

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE 120 may include a communication manager 140. As described in more detail elsewhere herein, the communication manager 140 may receive a first physical downlink control channel (PDCCH) communication; receive a second PDCCH communication after receiving the first PDCCH communication; and transmit, based at least in part on receiving the second PDCCH, time-domain channel state information (TD-CSI) feedback for one or more associated CSI reference signal (CSI-RS) occasions. Additionally, or alternatively, the communication manager 140 may perform one or more other operations described herein.

In some aspects, a network node 110 may include a communication manager 150. As described in more detail elsewhere herein, the communication manager 150 may transmit a first PDCCH communication; transmit a second PDCCH communication after transmitting the first PDCCH communication; and receive, based at least in part on the second PDCCH, TD-CSI feedback for one or more CSI-RS occasions. Additionally, or alternatively, the communication manager 150 may perform one or more other operations described herein.

As indicated above, FIG. 1 is provided as an example. Other examples may differ from what is described with regard to FIG. 1.

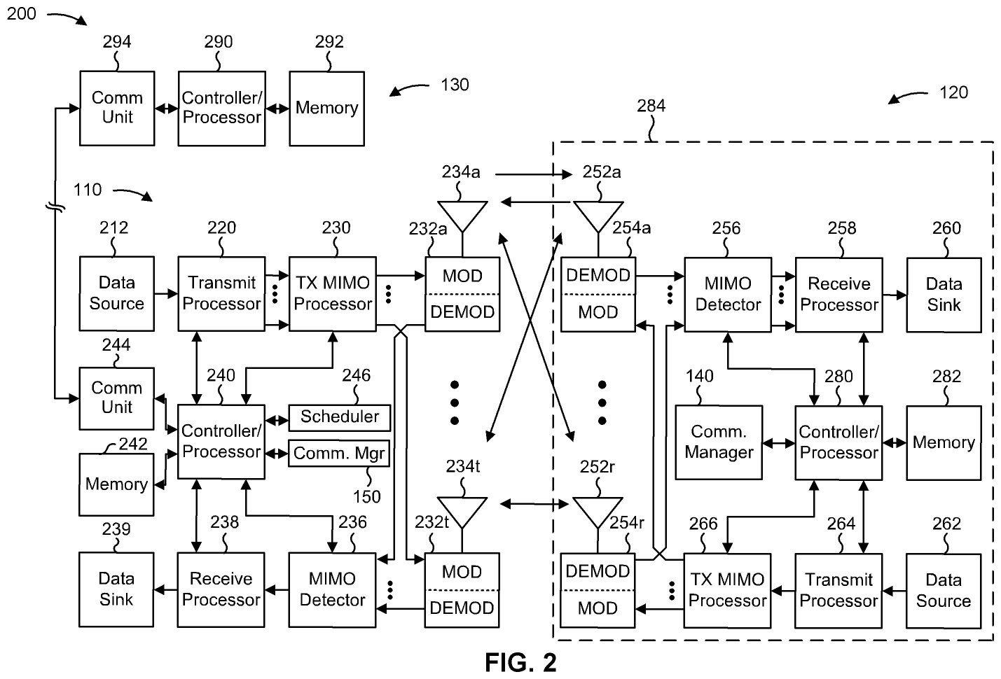

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

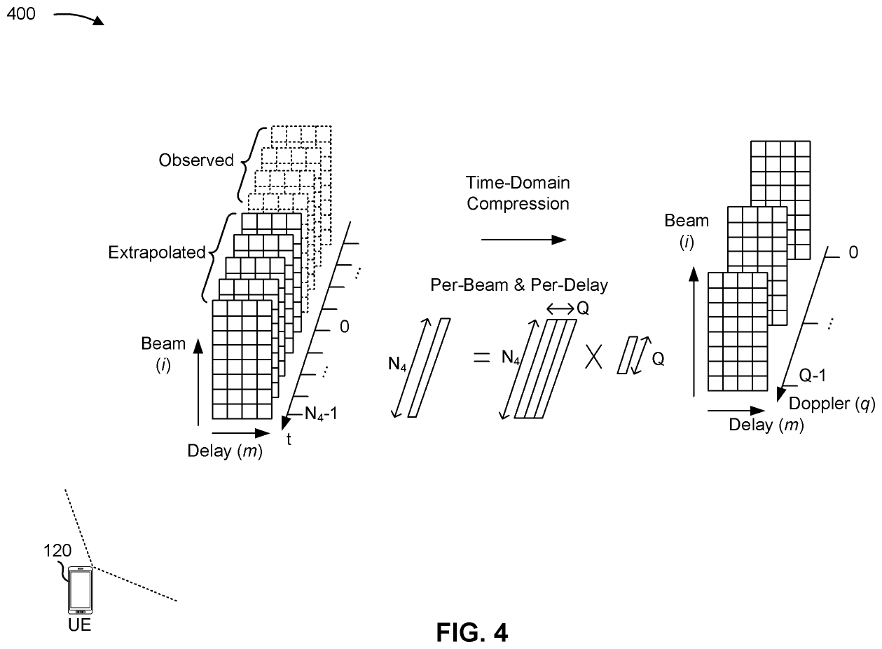

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-13).

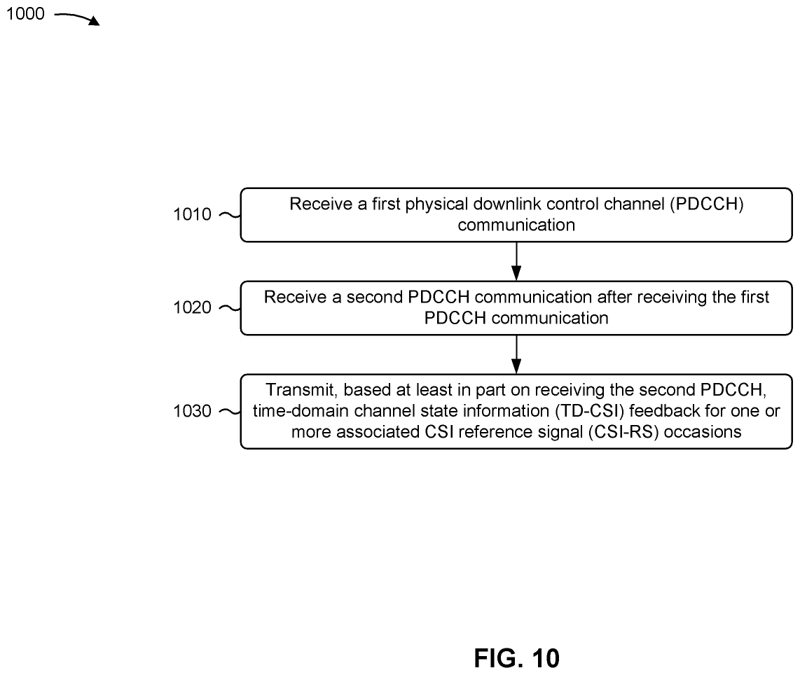

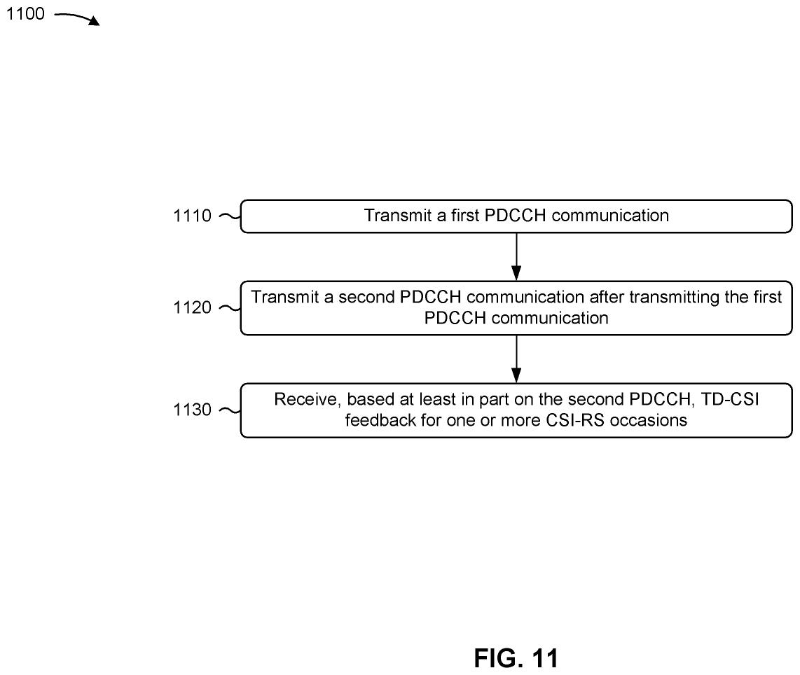

The controller/processor 240 of the network node 110, the controller/processor 280 of the UE 120, and/or any other component(s) of FIG. 2 may perform one or more techniques associated with two-stage PDCCH communications for TD-CSI triggering, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, the UE 120 includes means for receiving a first PDCCH communication; means for receiving a second PDCCH communication after receiving the first PDCCH communication; and/or means for transmitting, based at least in part on receiving the second PDCCH, TD-CSI feedback for one or more associated CSI-RS occasions. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a first PDCCH communication; means for transmitting a second PDCCH communication after transmitting the first PDCCH communication; and/or means for receiving, based at least in part on the second PDCCH, TD-CSI feedback for one or more CSI-RS occasions. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

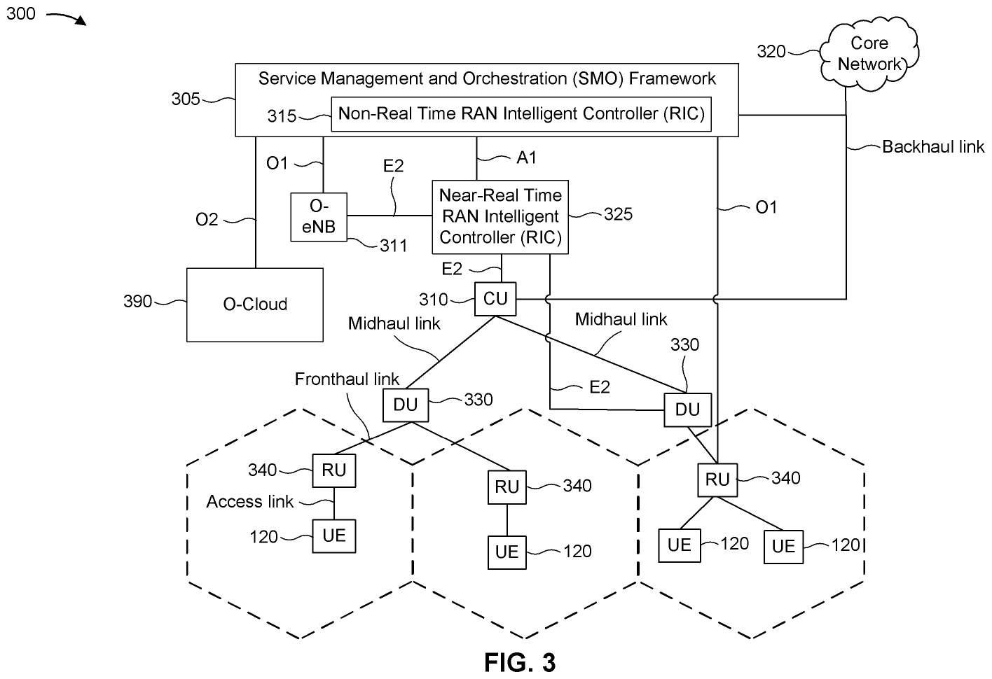

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/MUL models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram of an example 400 of precoding using a Type-II codebook, in accordance with the present disclosure.

In some cases, CSI reporting enhancements for medium and/or high velocity UEs (e.g., UEs that are moving at medium or high velocities) may be achieved through the use of time-domain correlation and Doppler-domain information to assist with downlink precoding. A UE may report time-domain channel properties to a network node to facilitate Type-II codebook refinement without modification to special and/or frequency domain bases. The UE may measure the time-domain channel properties via CSI-RSs transmitted by the network node. This may enable Type-II codebook refinement for time-domain CSI for extrapolation of channel predictions and reduced reporting overhead, among other examples.

In Release 16 of 5G NR, a Type-II codebook for CSI feedback may indicate a precoding matrix for a layer:

$$W = {W}_{1} \times \tilde{{W}_{2}} \times {W}_{f}^{H}$$

where W₁ corresponds to selected spatial domain (SD) bases, W_{f} corresponds to selected frequency domain (FD) bases, and \tilde{W}₂ corresponds to a coefficient matrix. W corresponds to the precoder that is to be used for a subsequent transmission.

In Release 18 of 5G NR, time-domain codebooks may be used to represent a fast-varying channel precoding matrix for medium to high velocity channels (e.g., for UEs that are moving at medium to high velocities).

As shown in the example 400 in FIG. 4, a time-domain codebook may be used to represent a fast-varying channel precoding matrix W over time instance n:

$$W ( n ) = {W}_{1} \times \tilde{{W}_{2}} ( n ) \times {W}_{f}^{H}$$

where a UE 120 measures bursts of CSI-RS occasions (the “observed” occasions indicated in FIG. 4) and extrapolates or predicts CSI-RS occasions (the “extrapolated” occasions indicated in FIG. 4) to obtain subsequent precoders W(n) over time t from n=0, . . . , N₄−1. Each burst may be measured based on delay (m) and beam (i). The UE 120 may assume the spatial domain bases W₁ and the frequency domain bases W_{f} to be constant over time t.

The UE 120 may perform time-domain compression of an extrapolated coefficient matrix \tilde{W}₂ into the Doppler domain (q) for overhead reduction. The extrapolated coefficient matrix \tilde{W}₂ may be determined as:

$$\tilde{{W}_{2}} ( n ) , n = 0 , … , {N}_{4} - 1$$

Time-domain compression may be performed on a per-beam and per-delay basis for each Doppler instance Q from Q=1, . . . Q=Q−1.

As indicated above, FIG. 4 is provided as an example. Other examples may differ from what is described with regard to FIG. 4.

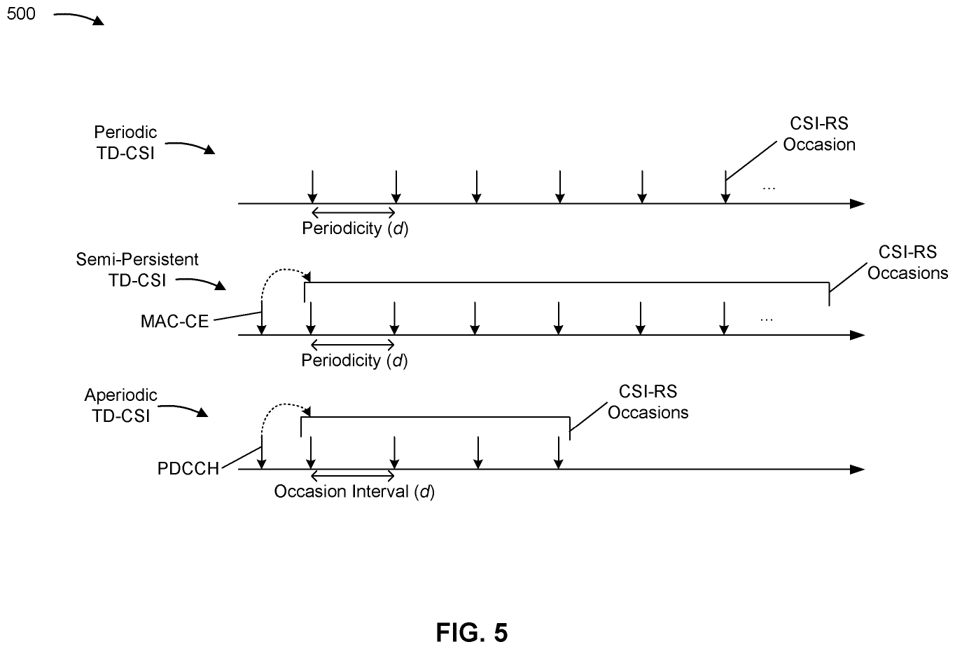

FIG. 5 is a diagram of examples 500 associated with TD-CSI, in accordance with the present disclosure. The examples 500 include examples of CSI-RS transmission implementations for TD-CSI measurement. The examples of CSI-RS transmission implementations illustrated in FIG. 5 may be used to support precoding matrix selection for fast-varying channel precoding.

For CSI reporting and measurement for the Release 18 Type-II codebook (and/or for subsequent releases), support for CSI-RS resource types/structures for CMR for refinement for high/medium velocities may include time-domain behavior for various types of non-zero-power (NZP) CSI-RS resources. Examples include periodic (P) TD-CSI, semi-persistent (SP) TD-CSI, and/or aperiodic (AP) TD-CSI, among other examples. Support for only one NZP CSI-RS resource for P or SP CSI-RS-based channel measurement may be provided. Alternatively, support for K (K>1) NZP CSI-RS resources, received via a single triggering instance, for AP CSI-RS-based channel measurement in a same CSI-RS resource set where the separation between 2 consecutive AP-CSI-RS resources is m slot(s) may be provided.

As shown in FIG. 5, periodic TD-CSI may include a plurality of CSI-RS occasions (e.g., time-domain resources that are allocated for CSI-RS transmission) that are spaced apart in the time domain by periodicity (d). The CSI-RS occasions may be configured by radio resource control (RRC) signaling.

As further shown in FIG. 5, semi-persistent TD-CSI may include a plurality of CSI-RS occasions that are spaced apart in the time domain by periodicity d. The CSI-RS occasions may be configured by RRC signaling and activated by medium access control (MAC) control element (MAC-CE) signaling. In some aspects, MAC-CE signaling is used to activate the CSI-RS occasions for a particular quantity of occasions. In some aspects MAC-CE signaling is used to activate the CSI-RS occasions until subsequent MAC-CE signaling deactivates the CSI-RS occasions.

As further shown in FIG. 5, aperiodic TD-CSI may include one or more CSI-RS occasions that are spaced apart in the time domain by occasion interval (d). The CSI-RS occasion(s) may be triggered by PDCCH signaling (e.g., downlink control information (DCI)).

As indicated above, FIG. 5 is provided as an example. Other examples may differ from what is described with regard to FIG. 5.

For some types of TD-CSI reporting, such as aperiodic TD-CSI reporting, among other types, PDCCH-to-physical uplink shared channel (PUSCH) distance should be long enough to accommodate a burst of CSI-RS occasions, and to accommodate CSI processing timelines of a UE. In other words, a sufficient amount of time between the PDCCH communication that triggers the CSI-RS occasions and the time at which the TD-CSI feedback for the CSI-RS occasions is transmitted in a PUSCH communication should be provided to enable a UE to perform measurements of the CSI-RSs transmitted in the CSI-RS occasions, and to generate the TD-CSI feedback. As an example, a CSI-RS burst of 4 occasions with 4-slot periodicity can result in a burst duration of at least 13 slots. With a CSI processing timeline of 5 slots (e.g., 69 symbols for 30 kilohertz (kHz) subcarrier spacing), the PDCCH-to-PUSCH distance may be 18 slots in total.

Enabling the UE to have sufficient time to perform measurements of the CSI-RSs and to generate the TD-CSI feedback may increase the latency for uplink shared channel (UL-SCH) information that is to be conveyed in the PUSCH communication along with the TD-CSI feedback. Moreover, enabling the UE to have sufficient time to perform measurements of the CSI-RSs and to generate the TD-CSI feedback may reduce uplink throughput for the UE due to the rigidity of uplink hybrid automatic repeat request (HARQ) rule in the time domain. Thus, if a first PDCCH communication schedules a first PUSCH communication for the TD-CSI feedback, a second (subsequent) PDCCH communication cannot schedule a second PUSCH communication until the UE measures the associated CSI-RS occasions, generates the TD-CSI feedback for the first PUSCH communication, and transmits the first PUSCH communication, if out-of-order scheduling is not permitted. This restriction occurs even with different HARQ process identifiers for the first and second PUSCH communications.

Some aspects described herein provide two-stage physical downlink control channel communications for time-domain channel state information triggering. In some aspects described herein, a UE 120 receives two PDCCH communications for TD-CSI measurement and feedback reporting. A first PDCCH communication triggers TD-CSI measurement and computation for the UE 120, and a second (subsequent) PDCCH communication triggers a PUSCH communication in which the UE 120 is to transmit TD-CSI feedback based at least in part on the measurement and computation.

The two-stage physical downlink control channel communications enables the UE 120 to provide another PUSCH communication between reception of the first PDCCH communication and the second PDCCH communication, which can be seen as an acknowledgement from the UE 120 indicating that the UE 120 did not miss the first PDCCH communication. This enables an associated network node 110 to move forward with scheduling the second PDCCH communication without causing HARQ processes to become out of order. The other PUSCH communication between reception of the first PDCCH communication and reception of the second PDCCH communication also provides the UE 120 with an opportunity to provide UL-SCH data to the network node 110, which reduces latency for the UL-SCH data relative to waiting to transmit the UL-SCH data with the TD-CSI feedback.

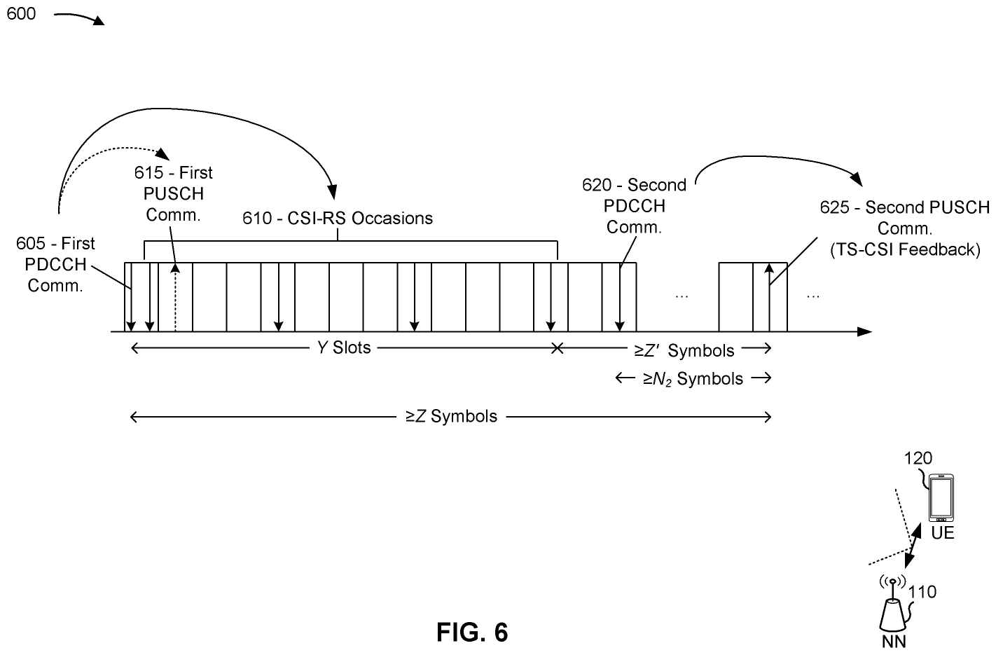

FIG. 6 is a diagram of an example 600 associated with two-stage physical downlink control channel communications for time-domain channel state information triggering, in accordance with the present disclosure. As shown in FIG. 6, the example 600 may include communication between a UE 120 and a network node 110. The UE 120 and the network node 110 may communicate on an uplink and a downlink in a wireless network, such as the wireless network 100. In some aspects, the network node 110 may be implemented as a disaggregated base station architecture 300, as illustrated in the example in FIG. 3.

As shown in FIG. 6, at 605, the network node 110 may transmit a first PDCCH communication to the UE 120, and the UE 120 may receive the first PDCCH communication from the network node 110. The first PDCCH communication may trigger measurement and/or computation of one or more CSI-RS occasions for TD-CSI feedback. The first PDCCH communication is a communication that is transmitted on (and received on) a PDCCH between the UE 120 and the network node 110.

In some aspects, the first PDCCH communication triggers a burst of CSI-RS transmissions (e.g., by the network node 110) in a plurality of aperiodic CSI-RS occasions at 610. Alternatively, the CSI-RS transmissions that occur in the CSI-RS occasions at 610 may be periodic (e.g., RRC configured) or semi-periodic (MAC-CE activated) CSI-RS transmissions.

In some aspects, the network node 110 may use a PUSCH grant DCI (e.g., format 0_1, format 0_2) for the first PDCCH communication. The network node 110 may use the PUSCH grant DCI for the first PDCCH communication because this particular uplink grant DCI may already have a CSI request field. This enables the network node 110 to trigger an uplink response from the UE 120 at 615 in a first PUSCH communication, without the UE 120 needing to transmit the TD-CSI feedback for the CSI-RS occasions in the first PUSCH communication. This first PUSCH communication can be seen as the UE 120 transmitting (e.g., to the network node 110) an acknowledgement of the first PDCCH communication in the first PUSCH communication at 615, which may indicate that the UE 120 did not miss the first PDCCH communication. In this way, the network node 110 may receive the acknowledgement and may continue with scheduling the report for the TD-CSI feedback. The first PUSCH communication is a communication that is transmitted on a PUSCH between the UE 120 and the network node 110.

For the first PDCCH communication, the UE 120 may not expect to be indicated a UCI-only transmission for the first PUSCH communication (e.g., only a transmission of TD-CSI and no other UCI such as HARQ feedback or legacy non-TD CSI). At the time that the first PUSCH communication is to be transmitted, the UE 120 may not have been given sufficient time to measure the CSI-RS occasion(s) and generate the TD-CSI feedback. If the first PDCCH communication indicates a UCI-only PUSCH for the first PUSCH communication, the UE 120 may refrain from transmitting the first PUSCH communication. Alternatively, if the first PDCCH communication indicates a UCI-only PUSCH for the first PUSCH communication with no other UCI such as HARQ feedback or legacy non-TD CSI, the UE 120 may refrain from transmitting the first PUSCH communication. Alternatively, if the first PDCCH communication indicates a UCI-only PUSCH for the first PUSCH communication, the UE 120 may still transmit the first PUSCH communication with arbitrary payloads (e.g., randomly selected data or simply zero-padding) and may maintain the acknowledgement in the first PUSCH communication indicating that the UE 120 did not miss the first PDCCH communication. Alternatively, an RRC-configuration, or additional DCI indication in a second PDCCH communication, may be provided to indicate whether trigger new AP-CSI-RS burst(s) or not. Alternatively, the second PDCCH communication also triggers AP-CSI-RS burst(s) for a new TD CSI report (e.g., as a “new” first PDCCH communication).

In some aspects, the UE 120 transmits the first PUSCH communication to the network node 110 after reception of the first PDCCH communication and prior to reception of a second PDCCH communication that schedules the report for the TD-CSI feedback. In some aspects, the UE 120 transmits the first PUSCH communication to the network node 110 after reception of the first PDCCH communication and prior to a first CSI-RS occasion in the one or more CSI-RS occasions. In some aspects, the UE 120 transmits the first PUSCH communication to the network node 110 after reception of the first PDCCH communication and prior to a last CSI-RS occasion of the one or more CSI-RS occasions.

The UE 120 may perform measurements of the CSI-RS(s) that are transmitted by the network node 110 in the one or more CSI-RS occasions. The measurements may include an RSSI measurement, an RSRP measurement, an RSRQ measurement, a CQI measurement, and/or another type of measurement. The CSI-RS transmission may occur across Y slots (e.g., 13 slots, 5 slots, 8 slots) between transmission of the first PDCCH communication as the last CSI-RS occasion in the one or more CSI-RS occasions. The UE 120 may generate the TD-CSI feedback based at least in part on the results of the measurements.

At 620 in FIG. 6, the network node 110 may transmit a second PDCCH communication to the UE 120, and the UE 120 may receive the second PDCCH communication from the network node 110. In some aspects, the network node 110 transmits (and the UE 120 receives) the second PDCCH communication after the last CSI-RS occasion in the one or more CSI-RS occasions. In some aspects, the network node 110 transmits (and the UE 120 receives) the second PDCCH communication prior to the last CSI-RS occasion in the one or more CSI-RS occasions. The second PDCCH communication is a communication that is transmitted on a PDCCH between the UE 120 and the network node 110.

The second PDCCH communication may include an uplink (e.g., PUSCH) grant DCI that triggers the report for the TD-CSI feedback. The uplink grant DCI format may include an AP-CSI triggering format or another type of format that includes a CSI request field. For the linkage between the first PDCCH communication and the second PDCCH communication, the first PDCCH communication and the second PDCCH communication may each include a same AP-CSI triggering state in respective CSI request fields in each of the first PDCCH communication and the second PDCCH communication.

A CSI measurement configuration (CSI-MeasConfig) for the UE 120 may include a CSI aperiodic triggering state list (CSI-AperiodicTriggerSTateList) that indicates one or more AP-CSI triggering states that may be used for the CSI request field in the first PDCCH communication and the second PDCCH communication. A CSI aperiodic triggering state list may include one or more CSI reporting configurations (CSI-ReportConfig). A CSI reporting configuration may configure channel measurements and/or interference measurements, among other examples, and a CSI resource configuration (CSI-ResourceConfig) for the measurements.

The CSI resource configuration may include one or more NZP CSI-RS resource sets (NZP-CSI-RS-ResourceSet). An NZP CSI-RS resource set may include a CSI synchronization signal block (SSB) resource set (CSI-SSB-ResourceSet), a CSI interference measurement (IM) resource set (CSI-IM-ResourceSet), and/or another type of CSI resource set. Each NZP CSI-RS resource set may include one or more NZP CSI-RS resources (NZP-CSI-RS-Resource), such as one or more SSB indexes (SSB-Index), one or more interference measurement resources (CSI-IM-Resource), and/one or more resources of another type.

In some aspects, the second PDCCH communication may trigger a subsequent burst (e.g., an AP-CSI-RS burst) of CSI-RS occasions. The second PDCCH communication may include an additional DCI indication (e.g., another field that is in addition to the CSI request field in the second PDCCH communication) to indicate whether a new burst of CSI-RS occasions is triggered. Alternatively, the network node 110 may refrain from triggering additional CSI-RS bursts in the second PDCCH communication for TD-CSI, even if the CSI request field in the second PDCCH communication indicates an AP-CSI triggering state.

At 625, the UE 120 may transmit (and the network node 110 may receive) the TD-CSI feedback in a second PUSCH communication. The TD-CSI feedback may be included in a report in the second PUSCH communication. The UE 120 may transmit the TD-CSI feedback based at least in part on the uplink grant DCI received in the second PDCCH communication. The second PUSCH communication is a communication that is transmitted on a PUSCH between the UE 120 and the network node 110.

The UE 120 may transmit the TD-CSI feedback after processing the measurements of the CSI-RS occasions and after generating the report. Due to the CSI processing time for the measurements and report generation, the timeline provided to the UE 120 for transmitting the report in the second PUSCH communication may be configured to satisfy one or more timing thresholds.

For example, a latest CSI-RS occasion to the second PUSCH communication timing (LatestCSIRSoccasion-to-PUSCH2) may be configured to satisfy Z′ symbols (e.g., may be configured to be greater than or equal to Z′ symbols) between the last CSI-RS occasion in the one or more CSI-RS occasions and the transmission of the second PUSCH communication.

For an aperiodic burst of the CSI-RS occasions at 610, the latest CSI-RS occasion for the LatestCSIRSoccasion-to-PUSCH2 parameter may correspond to the last CSI-RS occasion triggered by the first PDCCH communication. For periodic or semi-persistent CSI-RS occasions at 610, a minimum number (N_{ob,min}) of CSI-RS occasions may be defined after the first PDCCH communication. The latest CSI-RS occasion for the LatestCSIRSoccasion-to-PUSCH2 parameter may correspond to the N_{ob,min}th CSI-RS occasion after the first PDCCH communication.

Additionally and/or alternatively, the timeline provided to the UE 120 for transmitting the report in the second PUSCH communication may be configured to satisfy Z symbols (e.g., may be configured to be greater than or equal to Z symbols) between reception of the first PDCCH communication and transmission of the second PUSCH communication.

Additionally and/or alternatively, the timeline provided to the UE 120 for transmitting the report in the second PUSCH communication may be configured to satisfy N₂ symbols (e.g., may be configured to be greater than or equal to N₂ symbols) between reception of the second PDCCH communication and transmission of the second PUSCH communication.

As indicated above, FIG. 6 is provided as an example. Other examples may differ from what is described with regard to FIG. 6.

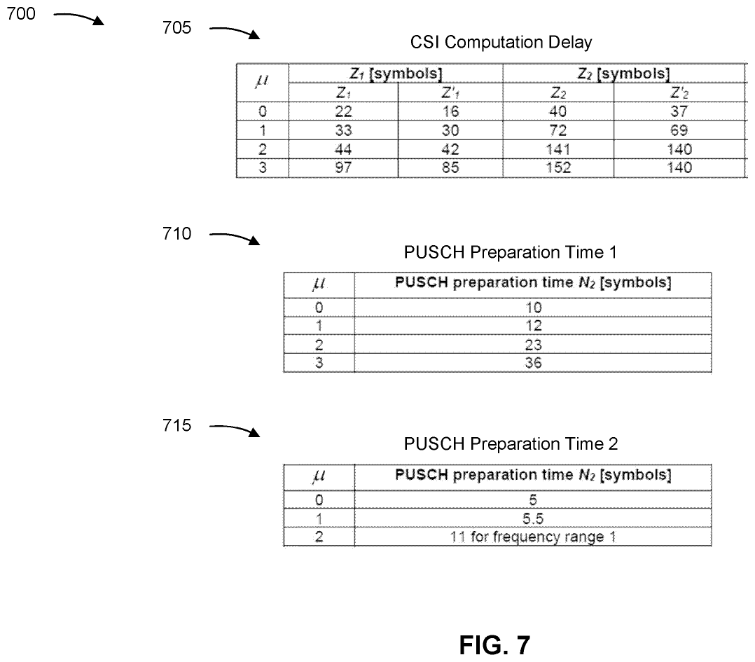

FIG. 7 is a diagram of an example 700 associated with two-stage physical downlink control channel communications for time-domain channel state information triggering, in accordance with the present disclosure.

As shown in the example 700, one or more tables 705-715 may be used (e.g., by a UE 120, by a network node 110) to determine a CSI computation delay and/or a PUSCH preparation time for measuring CSI-RS occasions and generating TD-CSI feedback based at least in part on results of the measurements. As shown in table 705, indexes (corresponding to u) may be included in respective rows in the table 705. Each index may include a plurality of columns that indicate symbol values for the Z symbols and Z′ symbols parameters described in connection with FIG. 6. The indexes may correspond to UEs having different processing capabilities, different processing system configurations, and/or one or more other parameters.

The table 710 may include indexes (corresponding to u) in respective rows in the table 710. Each index may include a column that indicate symbol values for the N₂ symbol parameter described in connection with FIG. 6 for PUSCH preparation time of the TD-CSI feedback report for the second PUSCH communication. The indexes may correspond to UEs having different processing capabilities, different processing system configurations, and/or one or more other parameters.

The table 715 may include indexes (corresponding to u) in respective rows in the table 715. Each index may include a column that indicate symbol values for the N₂ symbol parameter described in connection with FIG. 6 for PUSCH preparation time of the TD-CSI feedback report for the second PUSCH communication. The indexes may correspond to UEs having different processing capabilities, different processing system configurations, and/or one or more other parameters.

As indicated above, FIG. 7 is provided as examples. Other examples may differ from what is described with regard to FIG. 7.

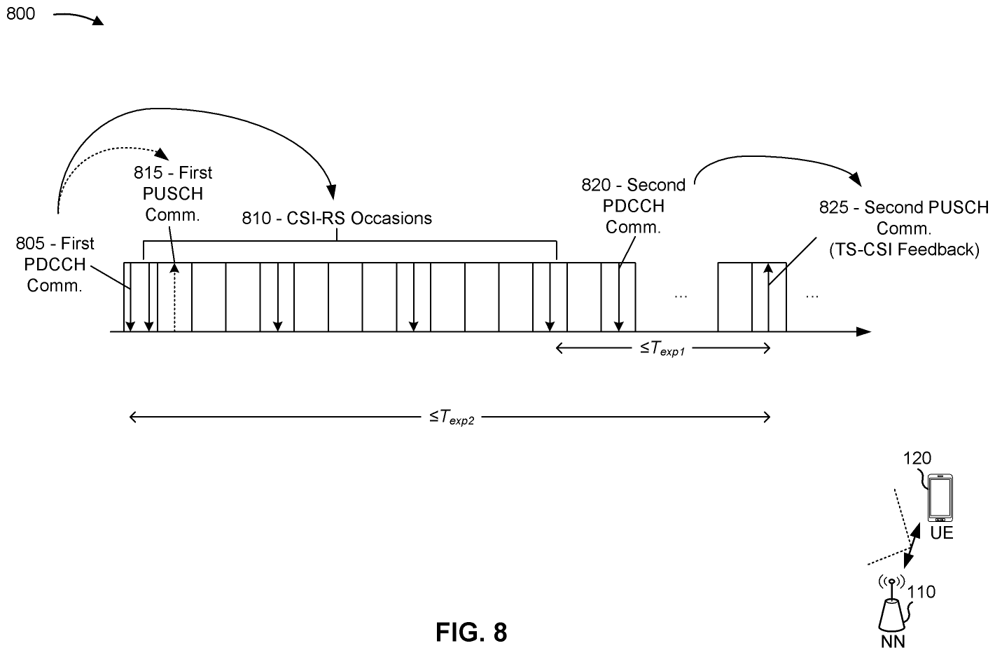

FIG. 8 is a diagram of an example 800 associated with two-stage physical downlink control channel communications for time-domain channel state information triggering, in accordance with the present disclosure. As shown in FIG. 8, the example 800 may include communication between a UE 120 and a network node 110. The UE 120 and the network node 110 may communicate on an uplink and a downlink in a wireless network, such as the wireless network 100. In some aspects, the network node 110 may be implemented as a disaggregated base station architecture 300, as illustrated in the example in FIG. 3.

As further shown in FIG. 8, the example 800 may include operations 805-825 that are similar to the operations 605-825 described above in connection with the example 600 of FIG. 6. At 825, the UE 825 may transmit the second PUSCH communication to report TD-CSI feedback to the network node 110 for the CSI-RS occasion(s) at 810. The UE 120 may transmit the TD-CSI feedback after processing the measurements of the CSI-RS occasions and after generating the report. Due to the CSI processing time for the measurements and report generation, the timeline provided to the UE 120 for transmitting the report in the second PUSCH communication may be configured to satisfy one or more timing thresholds.

The UE 120 and/or the network node 110 may track the CSI processing time for the measurements and report generation using one or more timers. The one or more timers may be defined to prevent an uplink buffer for the UE 120 from being occupied for too much time. The one or more timers may define an allowable time occasion for the second PUSCH communication. If the second PUSCH communication is scheduled after expiration of the one or more timers, even with the same indicated AP-CSI triggering state in the second PDCCH communication, the UE 120 and/or the network node 110 may consider the second PUSCH communication to be a new PDCCH communication (e.g., a new “first” PDCCH communication) that triggers a subsequent set of CSI-RS occasions for TD-CSI measurement.

In some aspects, the UE 120 and/or the network node 110 may track the CSI processing time for the measurements and report generation using a Tₑₓₚ₁ timer, which may run from the last CSI-RS occasion to transmission of the second PUSCH communication (e.g., the LatestCSIRSoccasion-to-PUSCH2 parameter described above in connection with FIG. 6). The scheduling of the second PUSCH communication may be performed to satisfy the Tₑₓₚ₁ timer (e.g., such that the time duration from the last CSI-RS occasion to transmission of the second PUSCH communication is less than or equal to Tₑₓₚ₁ or such that the time duration from the last CSI-RS occasion to transmission of the second PUSCH communication is less than or equal to Tₑₓₚ₁+Z′).

In some aspects, the UE 120 and/or the network node 110 may track the CSI processing time for the measurements and report generation using a Tₑₓₚ₂ timer, which may run from reception of the first PDCCH communication to transmission of the second PUSCH communication (e.g., PDCCH1-to-PUSCH2, corresponding to the Z symbols parameter described above in connection with FIG. 6). The scheduling of the second PUSCH communication may be performed to satisfy the Tₑₓₚ₂ timer (e.g., such that the time duration from reception of the first PDCCH communication to transmission of the second PUSCH communication is less than or equal to Tₑₓₚ₂ or such that the time duration from reception of the first PDCCH communication to transmission of the second PUSCH communication is less than or equal to Tₑₓₚ₂+Z).

As indicated above, FIG. 8 is provided as an example. Other examples may differ from what is described with regard to FIG. 8.

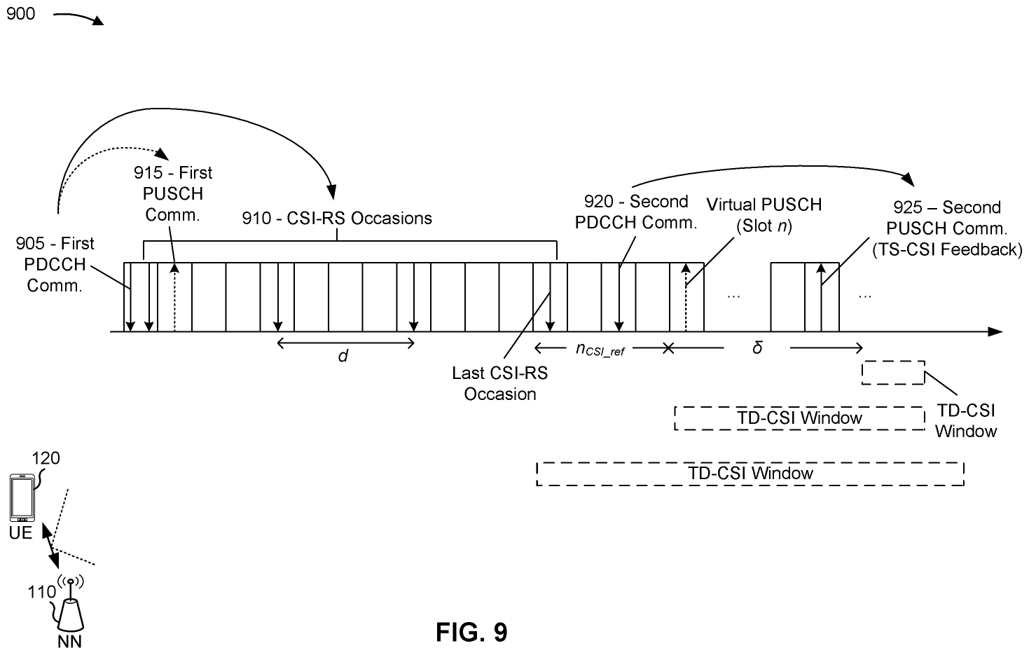

FIG. 9 is a diagram of an example 900 associated with two-stage physical downlink control channel communications for time-domain channel state information triggering, in accordance with the present disclosure. As shown in FIG. 9, the example 900 may include communication between a UE 120 and a network node 110. The UE 120 and the network node 110 may communicate on an uplink and a downlink in a wireless network, such as the wireless network 100. In some aspects, the network node 110 may be implemented as a disaggregated base station architecture 300, as illustrated in the example in FIG. 3.

As further shown in FIG. 9, the example 900 may include operations 905-925 that are similar to the operations 605-625 described above in connection with the example 600 of FIG. 6. At 925, the UE 925 may transmit the second PUSCH communication to report TD-CSI feedback to the network node 110 for the CSI-RS occasion(s) at 910. The UE 120 may determine a TD-CSI window in which the UE 120 is to transmit the second PUSCH communication with the TD-CSI feedback.

The time location of the TD-CSI window may have a starting slot l. In some cases, the starting slot l may be determined based at least in part on a CSI reference resource, a report slot n, and/or based at least in part on another parameter. The size of the TD-CSI window may be determined as

$${W}_{CSI} = {dN}_{4}$$

where d is the time interval between two consecutive CSI-RS occasions of a CSI-RS burst for TD-CSI measurement.

The CSI reference resource may be defined for validation testing (e.g., target block error rate (BLER) of approximately 10% or another percentage) with the reported CQI (and precoding matrix index (PMI), if also reported). The CSI reference resource may be specified in a wireless communication standard, such as Section 5.2.2.5 of 3GPP TS 38.214. The CSI reference resource may include a frequency-domain resource (e.g., the same frequency resource as the measured CSI-RS in the frequency-domain), a time-domain resource (e.g., a valid downlink slot n−n_{CSI_ref} prior to the uplink slot n where the TD-CSI is to be reported), and/or another resource.

For P/SP TD-CSI reports, n_{CSI_ref} may be the smallest value that ≥4·2^{μ}^{_{DL}} (single CSI-RS) or ≥5·2^{μ}^{_{DL}} (multiple CSI-RSs), such that slot n−n_{CSI_ref} corresponds to a valid downlink slot. For an aperiodic TD-CSI report, n_{CSI_ref} may be the smallest value that ≥└Z′/14┘, such that slot n−n_{CSI_ref} corresponds to a valid downlink slot (where Z′ is the required processing timeline for CSI-RS transmission to the reporting PUSCH).

On the CSI reporting and measurement for the Release 18 Type-II codebook refinement for high/medium velocity UEs, when UE-side prediction is assumed, the UE 120 may support “predicting” channel/CSI after starting slot l, where the location of starting slot l is configured (e.g., from multiple candidate values) by the network node 110 via higher-layer signalling. Candidates of the starting slot l location may include the legacy CSI reference resource location (n−n_{CSI,ref}) and slot (n+δ) where δ≥0. Per legacy behavior, the legacy CSI reference resource (e.g., n−n_{CSI,ref}) may be reused for locating the last CSI-RS occasion used for a CSI report. For a UE that supports UE-side prediction, the support of l=(n−n_{CSI,ref}) may be optional. Moreover, the supported value(s) for δ and W_{CSI} may be selected from the following candidates, in conjunction with the supported values of N₄ and delay-Doppler units. δ (slots): {0, 1, 2, 3, 4, 6, 8}, or a subset thereof with at least two values including 0, or a single fixed value (e.g., 0 or 1). W_{CSI} (slots): 1, N₄, following periodicity of P/SP-CSI-RS or SP-CSI (e.g., 4, 5, 8, 10, 16, 20, 40), dN₄ (d=Delay Doppler (DD) unit size in slots, N₄ is unit-less). However, other values for these parameters are within the scope of the present disclosure.

When two-stage physical downlink control channel communications are used for time-domain channel state information triggering, as described herein, the starting slot l may be determined by an indication in the first PDCCH communication before computation of the TD-CSI feedback occurs at the UE 120. However, since the first PDCCH communication only schedules the first PUSCH communication and not the second PUSCH communication conveying the TD-CSI feedback, the use of the slot of the first PUSCH communication as the starting slot l may result in the UE 120 missing the TD-CSI window for TD-CSI feedback reporting since the CSI-RS occasions may not be fully received and processed at the time of transmission of the first PUSCH communication.

As shown in FIG. 9, a virtual PUSCH may be defined at slot n for the determination of the TD-CSI window (W_{CSI}) location (e.g., for determining the starting slot l). The virtual PUSCH at slot n may be determined as └Z′/14┘ slots after the latest CSI-RS occasion of the CSI-RS occasions at 910. The processing occupation duration (e.g., central processing unit (CPU) occupation duration), for the UE 120 to process the measurements of the CSI-RS occasions and to generate the report for the TD-CSI feedback, may be determined as the time between the first PDCCH communication and the virtual PUSCH, the time between the first PDCCH communication and the second PUSCH communication, or the time from the first PDCCH communication to expiration of a timer (Tₑₓₚ₁ or Tₑₓₚ₂).

The CPU occupation duration may be specified in a wireless communication standard, such as Section 5.2.1.6 of 3GPP TS 38.214. For P/SP TD-CSI reports, a number of O_{CPU} CPUs of the UE 120 occupied is for a time duration from the first symbol of the earliest RS (CSI-RS/CSI-IM/SSB) in the latest occasion no later than the CSI reference resource, to the last symbol of PUSCH/PUCCH carrying the report for the TD-CSI feedback. For an aperiodic TD-CSI report, the number of O_{CPU} CPUs of the UE 120 occupied is for a time duration from PDCCH (CSI request DCI) to PUSCH (report).

The UE 120 and/or the network node 110 may determine the value of O_{CPU} using one or more techniques. For a normal case, UE 120 and/or the network node 110 may determine the value of O_{CPU}=K_{S} where K_{S} is the total number of CSI-RS resources in the CSI-RS resource set. For a special case 1 (e.g., a specification-defined fastest AP-CSI feedback with timeline defined in Table 5.4-1 in 3GPP TS 38.214), all CPUs are occupied (O_{CPU}=N_{CPU}). For a special case 2 (e.g., a non-coherent joint transmission (NCJT) case, where a CSI-RS resource set is configured with M TRP hypotheses and N 2-TRP (NCJT) hypotheses), the UE 120 and/or the network node 110 may determine the value of O_{CPU}=2N+M. The UE 120 can drop some lower-priority CSI reports until the total number

$${\sum }_{n} {O}_{CPU}^{( n )}$$

does not exceed N_{CPU} (total supported by the UE 120 for simultaneous CSI calculation).

For active CSI-RS resources/ports, the active duration may be determined based at least in part on a CSI-RS type. For P-CSI-RS, the RRC configuration to RRC release time may correspond to the active duration. For SP-CSI-RS, the MAC CE activation to deactivation time may correspond to the active duration. For A-CSI-RS, the triggering PDCCH (first symbol) to report PUSCH (last symbol) time may correspond to the active duration.

For the number of active ports/resources, if a CSI-RS resource is referred to as N times by one or more report settings, the CSI-RS resource/ports are counted N times. In any slot, the UE 120 is not expected to have more active CSI-RS ports or active CSI-RS resources in active bandwidth parts (BWPs) than reported as the capability of the UE 120. For a special case (e.g., an NCJT case, where a CSI-RS resource can be referred to as X>1 times by one report setting with TRP hypotheses and/or NCJT (2-TRP) hypotheses), the CSI-RS resource/ports are counted X times for this report setting.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with two-stage physical downlink control channel communications for time-domain channel state information triggering.

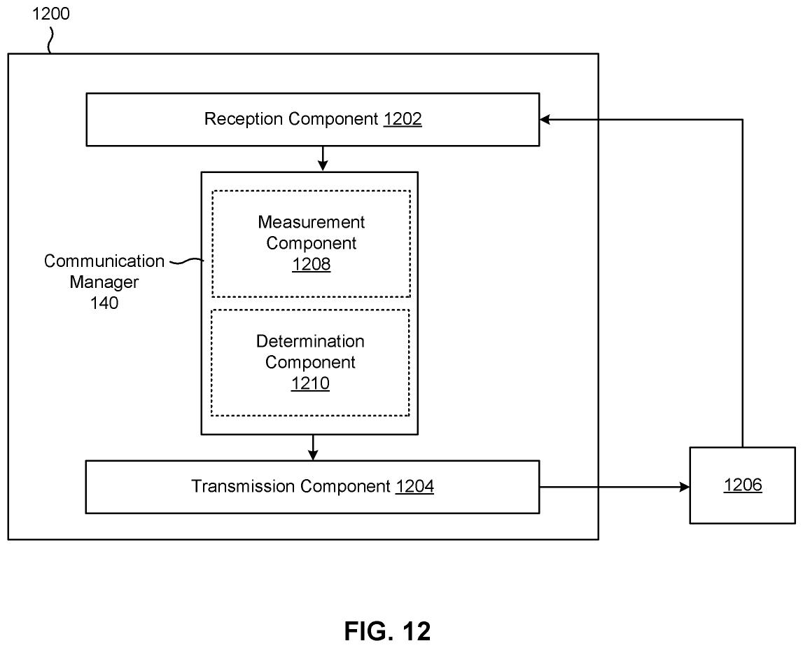

As shown in FIG. 10, in some aspects, process 1000 may include receiving a first PDCCH communication (block 1010). For example, the UE (e.g., using communication manager 140 and/or reception component 1202, depicted in FIG. 12) may receive a first PDCCH communication, as described above.

As further shown in FIG. 10, in some aspects, process 1000 may include receiving a second PDCCH communication after receiving the first PDCCH communication (block 1020). For example, the UE (e.g., using communication manager 140 and/or reception component 1202, depicted in FIG. 12) may receive a second PDCCH communication after receiving the first PDCCH communication, as described above.

As further shown in FIG. 10, in some aspects, process 1000 may include transmitting, based at least in part on receiving the second PDCCH, TD-CSI feedback for one or more associated CSI-RS occasions (block 1030). For example, the UE (e.g., using communication manager 140 and/or transmission component 1204, depicted in FIG. 12) may transmit, based at least in part on receiving the second PDCCH, TD-CSI feedback for one or more associated CSI-RS occasions, as described above.

Process 1000 may include additional aspects, such as any single aspect or any combination of aspects described below and/or in connection with one or more other processes described elsewhere herein.

In a first aspect, process 1000 includes performing, based at least in part on receiving the first PDCCH communication, one or more measurements of the one or more CSI-RS occasions.

In a second aspect, alone or in combination with the first aspect, the TD-CSI feedback is based at least in part on results of the one or more measurements.

In a third aspect, alone or in combination with one or more of the first and second aspects, transmitting the TD-CSI feedback comprises transmitting the TD-CSI feedback in a second PUSCH communication after receiving the second PDCCH communication.

In a fourth aspect, alone or in combination with one or more of the first through third aspects, the first PDCCH communication comprises downlink control information (DCI) that indicates an uplink grant.

In a fifth aspect, alone or in combination with one or more of the first through fourth aspects, the second PDCCH communication comprises DCI that indicates an uplink grant for transmission of the TD-CSI feedback.

In a sixth aspect, alone or in combination with one or more of the first through fifth aspects, the first PDCCH communication and the second PDCCH communication include respective CSI request fields that both indicate a same CSI triggering state.

In a seventh aspect, alone or in combination with one or more of the first through sixth aspects, transmission of the TD-CSI feedback is after a quantity of symbols, from a CSI-RS occasion of the one or more CSI-RS occasions, that satisfies a symbol quantity threshold.

In an eighth aspect, alone or in combination with one or more of the first through seventh aspects, the one or more CSI-RS occasions are included in an aperiodic CSI-RS burst that is scheduled by the first PDCCH communication, and the CSI-RS occasion is a last CSI-RS occasion in the aperiodic CSI-RS burst that is scheduled by the first PDCCH communication.

In a ninth aspect, alone or in combination with one or more of the first through eighth aspects, the one or more CSI-RS occasions comprise a plurality of periodic or semi-persistent CSI-RS occasions that are associated with the TD-CSI feedback, and the CSI-RS occasion is a periodic or semi-persistent CSI-RS occasion, of the plurality of periodic or semi-persistent CSI-RS occasions, that occurs after a threshold quantity of periodic or semi-persistent CSI-RS occasions from first PDCCH communication.

In a tenth aspect, alone or in combination with one or more of the first through ninth aspects, transmitting the TD-CSI feedback comprises transmitting the TD-CSI feedback after a quantity of symbols, from the first PDCCH communication, that satisfies a symbol quantity threshold.

In an eleventh aspect, alone or in combination with one or more of the first through tenth aspects, transmitting the TD-CSI feedback comprises transmitting the TD-CSI feedback after a quantity of symbols, from the second PDCCH communication, that satisfies a symbol quantity threshold.

In a twelfth aspect, alone or in combination with one or more of the first through eleventh aspects, transmitting the TD-CSI feedback comprises transmitting the TD-CSI feedback prior to expiration of a timer that is initiated based at least in part on a last CSI-RS occasion of the one or more CSI-RS occasions.

In a thirteenth aspect, alone or in combination with one or more of the first through twelfth aspects, transmitting the TD-CSI feedback comprises transmitting the TD-CSI feedback prior to expiration of a timer that is initiated based at least in part on the first PDCCH communication.

In a fourteenth aspect, alone or in combination with one or more of the first through thirteenth aspects, transmitting the TD-CSI feedback comprises determining a starting slot of a CSI window that occurs after a quantity of slots from a last CSI-RS occasion of the one or more CSI-RS occasions.

In a fifteenth aspect, alone or in combination with one or more of the first through fourteenth aspects, process 1000 includes determining a processing occupation duration, after reception of the first PDCCH communication and a starting slot of the CSI reporting window, for generating the TD-CSI feedback.

In a sixteenth aspect, alone or in combination with one or more of the first through fifteenth aspects, process 1000 includes determining a processing occupation duration, after reception of the first PDCCH communication and to a last symbol of transmission of the TD-CSI feedback, for generating the TD-CSI feedback.

In a seventeenth aspect, alone or in combination with one or more of the first through sixteenth aspects, process 1000 includes determining a processing occupation duration, after reception of the first PDCCH communication and expiration of a TD-CSI feedback timer, for generating the TD-CSI feedback.

In an eighteenth aspect, alone or in combination with one or more of the first through seventeenth aspects, the first PDCCH communication comprises DCI that indicates a PUSCH that is to include uplink data or another type of uplink control information other than the TD-CSI feedback.

In a nineteenth aspect, alone or in combination with one or more of the first through eighteenth aspects, the first PDCCH communication comprises DCI that indicates a UCI-only PUSCH that is not to include uplink data nor other types of UCI.

In a twentieth aspect, alone or in combination with one or more of the first through nineteenth aspects, process 1000 includes refraining from transmitting the PUSCH based at least in part on the UCI-only PUSCH being scheduled to not include uplink data nor other types of uplink control information.

In a twenty-first aspect, alone or in combination with one or more of the first through twentieth aspects, the first PDCCH communication comprises DCI that indicates a UCI-only physical uplink control channel (PUSCH) that is not to include uplink data nor other types of UCI, and process 1000 includes transmitting the UCI-only PUSCH along with one or more arbitrary payloads based at least in part on the UCI-only PUSCH being scheduled to not include uplink data nor other types of UCI.

In a twenty-second aspect, alone or in combination with one or more of the first through twenty-first aspects, the second PDCCH communication comprises DCI that indicates an uplink grant for transmission of the TD-CSI feedback, and does not trigger additional CSI-RS occasions.

In a twenty-third aspect, alone or in combination with one or more of the first through twenty-second aspects, the second PDCCH communication comprises DCI that indicates an uplink grant for transmission of the TD-CSI feedback, and an additional field that indicates whether additional CSI-RS occasions are triggered.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 110) performs operations associated with two-stage physical downlink control channel communications for time-domain channel state information triggering.

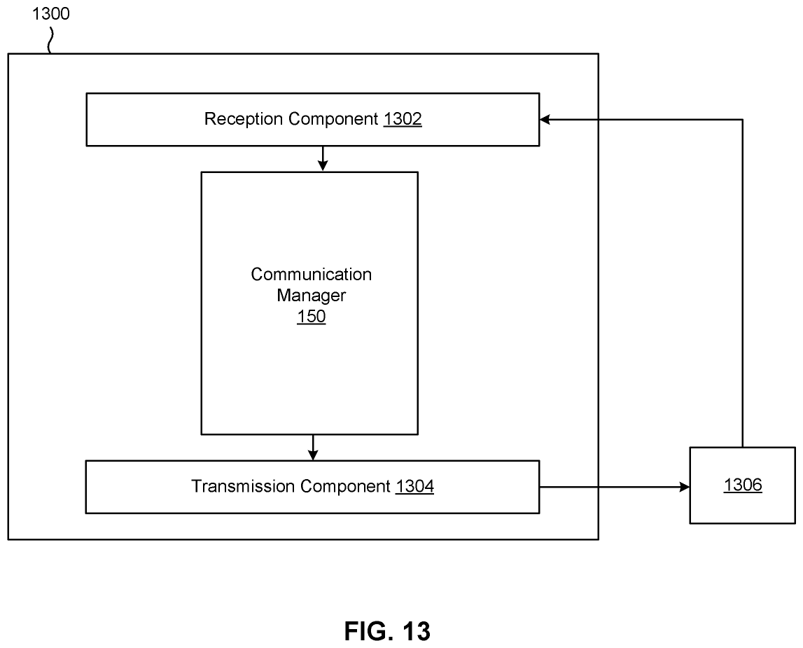

As shown in FIG. 11, in some aspects, process 1100 may include transmitting a first PDCCH communication (block 1110). For example, the network node (e.g., using communication manager 150 and/or transmission component 1304, depicted in FIG. 13) may transmit a first PDCCH communication, as described above.

As further shown in FIG. 11, in some aspects, process 1100 may include transmitting a second PDCCH communication after transmitting the first PDCCH communication (block 1120). For example, the network node (e.g., using communication manager 150 and/or transmission component 1304, depicted in FIG. 13) may transmit a second PDCCH communication after transmitting the first PDCCH communication, as described above.

As further shown in FIG. 11, in some aspects, process 1100 may include receiving, based at least in part on the second PDCCH, TD-CSI feedback for one or more CSI-RS occasions (block 1130). For example, the network node (e.g., using communication manager 150 and/or reception component 1302, depicted in FIG. 13) may receive, based at least in part on the second PDCCH, TD-CSI feedback for one or more CSI-RS occasions, as described above.

Process 1100 may include additional aspects, such as any single aspect or any combination of aspects described below and/or in connection with one or more other processes described elsewhere herein.

In a first aspect, the first PDCCH communication schedules the one or more CSI-RS occasions.

In a second aspect, alone or in combination with the first aspect, receiving the TD-CSI feedback comprises receiving the TD-CSI feedback in a second PUSCH communication after transmitting the second PDCCH communication.

In a third aspect, alone or in combination with one or more of the first and second aspects, transmitting the second PDCCH communication comprises transmitting the second PDCCH communication based at least in part on receiving a response to the first PDCCH communication.

In a fourth aspect, alone or in combination with one or more of the first through third aspects, the first PDCCH communication comprises DCI that indicates the response to the first PDCCH communication.

In a fifth aspect, alone or in combination with one or more of the first through fourth aspects, the second PDCCH communication comprises DCI that indicates an uplink grant.

In a sixth aspect, alone or in combination with one or more of the first through fifth aspects, the first PDCCH communication and the second PDCCH communication include respective CSI request fields that both indicate a same CSI triggering state.

In a seventh aspect, alone or in combination with one or more of the first through sixth aspects, the TD-CSI feedback is received after a quantity of symbols, from a CSI-RS occasion of the one or more CSI-RS occasions, that satisfies a symbol quantity threshold.

In an eighth aspect, alone or in combination with one or more of the first through seventh aspects, the one or more CSI-RS occasions are included in an aperiodic CSI-RS burst that is scheduled by the first PDCCH communication, and the CSI-RS occasion is a last CSI-RS occasion in the aperiodic CSI-RS burst that is scheduled by the first PDCCH communication.

In a ninth aspect, alone or in combination with one or more of the first through eighth aspects, the one or more CSI-RS occasions comprise a plurality of periodic or semi-persistent CSI-RS occasions that are associated with the TD-CSI feedback, and the CSI-RS occasion is a periodic or semi-persistent CSI-RS occasion, of the plurality of periodic or semi-persistent CSI-RS occasions, that occurs after a threshold quantity of periodic or semi-persistent CSI-RS occasions from first PDCCH communication.

In a tenth aspect, alone or in combination with one or more of the first through ninth aspects, the one or more CSI-RS occasions comprise a plurality of semi-persistent CSI-RS occasions that are activated by the first PDCCH communication, and the CSI-RS occasion is a semi-persistent CSI-RS occasion, of the plurality of semi-persistent CSI-RS occasions, that occurs after a threshold quantity of semi-persistent CSI-RS occasions from first PDCCH communication.

In an eleventh aspect, alone or in combination with one or more of the first through tenth aspects, receiving the TD-CSI feedback comprises receiving the TD-CSI feedback after a quantity of symbols, from the first PDCCH communication, that satisfies a symbol quantity threshold.

In a twelfth aspect, alone or in combination with one or more of the first through eleventh aspects, receiving the TD-CSI feedback comprises receiving the TD-CSI feedback after a quantity of symbols, from the second PDCCH communication, that satisfies a symbol quantity threshold.

In a thirteenth aspect, alone or in combination with one or more of the first through twelfth aspects, receiving the TD-CSI feedback comprises receiving the TD-CSI feedback prior to expiration of a timer that is initiated based at least in part on a last CSI-RS occasion of the one or more CSI-RS occasions.

In a fourteenth aspect, alone or in combination with one or more of the first through thirteenth aspects, receiving the TD-CSI feedback comprises receiving the TD-CSI feedback prior to expiration of a timer that is initiated based at least in part on the first PDCCH communication.

In a fifteenth aspect, alone or in combination with one or more of the first through fourteenth aspects, receiving the TD-CSI feedback comprises receiving the TD-CSI feedback in a CSI reporting window that occurs after a quantity of slots from a last CSI-RS occasion of the one or more CSI-RS occasions.

In a sixteenth aspect, alone or in combination with one or more of the first through fifteenth aspects, the first PDCCH communication comprises DCI that indicates a PUSCH, and uplink data or another type of uplink control information other than the TD-CSI feedback.

In a seventeenth aspect, alone or in combination with one or more of the first through sixteenth aspects, the first PDCCH communication comprises DCI that indicates a PUSCH, and no uplink data or no other types of uplink control information.

In an eighteenth aspect, alone or in combination with one or more of the first through seventeenth aspects, the first PDCCH communication comprises DCI that indicates a PUSCH, and does not trigger additional CSI-RS occasions.

In a nineteenth aspect, alone or in combination with one or more of the first through eighteenth aspects, the second PDCCH communication comprises DCI that indicates an uplink grant for transmission of the TD-CSI feedback, and an additional field that indicates whether additional CSI-RS occasions are triggered.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE 120, or a UE 120 may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a network node, or another wireless communication device) using the reception component 1202 and the transmission component 1204. As further shown, the apparatus 1200 may include the communication manager 140. The communication manager 140 may include one or more of a measurement component 1208, a determination component 1210, and/or another component, among other examples.

In some aspects, the apparatus 1200 may be configured to perform one or more operations described herein in connection with FIGS. 4-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive (e.g., from the apparatus 1206) a first PDCCH communication. The reception component 1202 may receive (e.g., from the apparatus 1206) a second PDCCH communication after receiving the first PDCCH communication. The transmission component 1204 may transmit (e.g., to the apparatus 1206), based at least in part on receiving the second PDCCH, TD-CSI feedback for one or more associated CSI-RS occasions.

The measurement component 1208 may perform, based at least in part on receiving the first PDCCH communication, one or more measurements of the one or more CSI-RS occasions.

The determination component 1210 may determine a processing occupation duration, after reception of the first PDCCH communication and a starting slot of the CSI reporting window, for generating the TD-CSI feedback.

The determination component 1210 may determine a processing occupation duration, after reception of the first PDCCH communication and to a last symbol of transmission of the TD-CSI feedback, for generating the TD-CSI feedback.

The determination component 1210 may determine a processing occupation duration, after reception of the first PDCCH communication and expiration of a TD-CSI feedback timer, for generating the TD-CSI feedback.

The transmission component 1204 may refrain from transmitting a PUSCH, associated with the first PDCCH communication, based at least in part on a PUSCH comprising no uplink data or no other types of uplink control information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node 110, or a network node 110 may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a network node, or another wireless communication device) using the reception component 1302 and the transmission component 1304. As further shown, the apparatus 1300 may include the communication manager 150.

In some aspects, the apparatus 1300 may be configured to perform one or more operations described herein in connection with FIGS. 4-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The transmission component 1304 may transmit (e.g., to the apparatus 1306) a first PDCCH communication. The transmission component 1304 may transmit (e.g., to the apparatus 1306) a second PDCCH communication after transmitting the first PDCCH communication. The reception component 1302 may receive (e.g., from the apparatus 1306), based at least in part on the second PDCCH, TD-CSI feedback for one or more CSI-RS occasions.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a first physical downlink control channel (PDCCH) communication; receiving a second PDCCH communication after receiving the first PDCCH communication; and transmitting, based at least in part on receiving the second PDCCH, time-domain channel state information (TD-CSI) feedback for one or more associated CSI reference signal (CSI-RS) occasions.

Aspect 2: The method of Aspect 1, further comprising: performing, based at least in part on receiving the first PDCCH communication, one or more measurements of the one or more CSI-RS occasions.

Aspect 3: The method of Aspect 2, wherein the TD-CSI feedback is based at least in part on results of the one or more measurements.

Aspect 4: The method of any of Aspects 1-3, wherein transmitting the TD-CSI feedback comprises: transmitting the TD-CSI feedback in a second PUSCH communication after receiving the second PDCCH communication.

Aspect 5: The method of any of Aspects 1-4, wherein the first PDCCH communication comprises downlink control information (DCI) that indicates an uplink grant.

Aspect 6: The method of any of Aspects 1-5, wherein the second PDCCH communication comprises downlink control information (DCI) that indicates an uplink grant for transmission of the TD-CSI feedback.

Aspect 7: The method of any of Aspects 1-6, wherein the first PDCCH communication and the second PDCCH communication include respective CSI request fields that both indicate a same CSI triggering state.

Aspect 8: The method of Aspect 7, wherein transmission of the TD-CSI feedback is after a quantity of symbols, from a CSI-RS occasion of the one or more CSI-RS occasions, that satisfies a symbol quantity threshold.

Aspect 9: The method of Aspect 8, wherein the one or more CSI-RS occasions are included in an aperiodic CSI-RS burst that is scheduled by the first PDCCH communication; and wherein the CSI-RS occasion is a last CSI-RS occasion in the aperiodic CSI-RS burst that is scheduled by the first PDCCH communication.

Aspect 10: The method of Aspect 8 or 9, wherein the one or more CSI-RS occasions comprise a plurality of periodic or semi-persistent CSI-RS occasions that are associated with the TD-CSI feedback; and wherein the CSI-RS occasion is a periodic or semi-persistent CSI-RS occasion, of the plurality of periodic or semi-persistent CSI-RS occasions, that occurs after a threshold quantity of periodic or semi-persistent CSI-RS occasions from first PDCCH communication.

Aspect 11: The method of any of Aspects 1-10, wherein transmitting the TD-CSI feedback comprises: transmitting the TD-CSI feedback after a quantity of symbols, from the first PDCCH communication, that satisfies a symbol quantity threshold.

Aspect 12: The method of any of Aspects 1-11, wherein transmitting the TD-CSI feedback comprises: transmitting the TD-CSI feedback after a quantity of symbols, from the second PDCCH communication, that satisfies a symbol quantity threshold.

Aspect 13: The method of any of Aspects 1-12, wherein transmitting the TD-CSI feedback comprises: transmitting the TD-CSI feedback prior to expiration of a timer that is initiated based at least in part on a last CSI-RS occasion of the one or more CSI-RS occasions.

Aspect 14: The method of any of Aspects 1-13, wherein transmitting the TD-CSI feedback comprises: transmitting the TD-CSI feedback prior to expiration of a timer that is initiated based at least in part on the first PDCCH communication.

Aspect 15: The method of any of Aspects 1-14, wherein transmitting the TD-CSI feedback comprises: determining a starting slot of a CSI window that occurs after a quantity of slots from a last CSI-RS occasion of the one or more CSI-RS occasions.

Aspect 16: The method of Aspect 15, further comprising: determining a processing occupation duration, after reception of the first PDCCH communication and a starting slot of the CSI reporting window, for generating the TD-CSI feedback.

Aspect 17: The method of any of Aspects 1-16, further comprising: determining a processing occupation duration, after reception of the first PDCCH communication and to a last symbol of transmission of the TD-CSI feedback, for generating the TD-CSI feedback.

Aspect 18: The method of any of Aspects 1-17, further comprising: determining a processing occupation duration, after reception of the first PDCCH communication and expiration of a TD-CSI feedback timer, for generating the TD-CSI feedback.

Aspect 19: The method of any of Aspects 1-18, wherein the first PDCCH communication comprises: downlink control information (DCI) that indicates a physical uplink control channel (PUSCH) that is to include uplink data or another type of uplink control information other than the TD-CSI feedback.

Aspect 20: The method of any of Aspects 1-19, wherein the first PDCCH communication comprises downlink control information (DCI) that indicates a UCI-only physical uplink control channel (PUSCH) that is not to include uplink data nor other types of uplink control information other than the TD-CSI feedback.

Aspect 21: The method of Aspect 20, further comprising: refraining from transmitting the UCI-only PUSCH based at least in part on the UCI-only PUSCH being scheduled to not include uplink data nor other types of uplink control information other than the TD-CSI feedback.

Aspect 22: The method of any of Aspects 1-21, wherein the first PDCCH communication comprises downlink control information (DCI) that indicates a UCI-only physical uplink control channel (PUSCH) that is not to include uplink data nor other types of uplink control information other than the TD-CSI feedback; and wherein the method further comprises: transmitting the UCI-only PUSCH along with one or more arbitrary payloads based at least in part on the UCI-only PUSCH being scheduled to not include uplink data nor other types of uplink control information other than the TD-CSI feedback.

Aspect 23: The method of any of Aspects 1-22, wherein the second PDCCH communication comprises downlink control information (DCI) that indicates an uplink grant for transmission of the TD-CSI feedback, and does not trigger additional CSI-RS occasions.

Aspect 24: The method of any of Aspects 1-23, wherein the second PDCCH communication comprises: downlink control information (DCI) that indicates an uplink grant for transmission of the TD-CSI feedback; and an additional field that indicates whether additional CSI-RS occasions are triggered.

Aspect 25: A method of wireless communication performed by a network node, comprising: transmitting a first physical downlink control channel (PDCCH) communication; transmitting a second PDCCH communication after transmitting the first PDCCH communication; and receiving, based at least in part on the second PDCCH, time-domain channel state information (TD-CSI) feedback for one or more CSI reference signal (CSI-RS) occasions.

Aspect 26: The method of Aspect 25, wherein the first PDCCH communication schedules the one or more CSI-RS occasions.

Aspect 27: The method of any of Aspects 25-26, wherein receiving the TD-CSI feedback comprises: receiving the TD-CSI feedback in a second PUSCH communication after transmitting the second PDCCH communication.

Aspect 28: The method of any of Aspects 25-27, wherein transmitting the second PDCCH communication comprises: transmitting the second PDCCH communication based at least in part on receiving a response to the first PDCCH communication.

Aspect 29: The method of Aspect 28, wherein the first PDCCH communication comprises downlink control information (DCI) that indicates the response to the first PDCCH communication.

Aspect 30: The method of any of Aspects 25-29, wherein the second PDCCH communication comprises downlink control information (DCI) that indicates an uplink grant.

Aspect 31: The method of any of Aspects 25-30, wherein the first PDCCH communication and the second PDCCH communication include respective CSI request fields that both indicate a same CSI triggering state.

Aspect 32: The method of any of Aspects 25-31, wherein the TD-CSI feedback is received after a quantity of symbols, from a CSI-RS occasion of the one or more CSI-RS occasions, that satisfies a symbol quantity threshold.

Aspect 33: The method of Aspect 32, wherein the one or more CSI-RS occasions are included in an aperiodic CSI-RS burst that is scheduled by the first PDCCH communication; and wherein the CSI-RS occasion is a last CSI-RS occasion in the aperiodic CSI-RS burst that is scheduled by the first PDCCH communication.

Aspect 34: The method of Aspect 32 or 33, wherein the one or more CSI-RS occasions comprise a plurality of periodic or semi-persistent CSI-RS occasions that are associated with the TD-CSI feedback; and wherein the CSI-RS occasion is a periodic or semi-persistent CSI-RS occasion, of the plurality of periodic or semi-persistent CSI-RS occasions, that occurs after a threshold quantity of periodic or semi-persistent CSI-RS occasions from first PDCCH communication.

Aspect 35: The method of any of Aspects 32-34, wherein the one or more CSI-RS occasions comprise a plurality of semi-persistent CSI-RS occasions that are activated by the first PDCCH communication; and wherein the CSI-RS occasion is a semi-persistent CSI-RS occasion, of the plurality of semi-persistent CSI-RS occasions, that occurs after a threshold quantity of semi-persistent CSI-RS occasions from first PDCCH communication.

Aspect 36: The method of any of Aspects 25-35, wherein receiving the TD-CSI feedback comprises: receiving the TD-CSI feedback after a quantity of symbols, from the first PDCCH communication, that satisfies a symbol quantity threshold.

Aspect 37: The method of any of Aspects 25-36, wherein receiving the TD-CSI feedback comprises: receiving the TD-CSI feedback after a quantity of symbols, from the second PDCCH communication, that satisfies a symbol quantity threshold.

Aspect 38: The method of any of Aspects 25-37, wherein receiving the TD-CSI feedback comprises: receiving the TD-CSI feedback prior to expiration of a timer that is initiated based at least in part on a last CSI-RS occasion of the one or more CSI-RS occasions.

Aspect 39: The method of any of Aspects 25-38, wherein receiving the TD-CSI feedback comprises: receiving the TD-CSI feedback prior to expiration of a timer that is initiated based at least in part on the first PDCCH communication.

Aspect 40: The method of any of Aspects 25-39, wherein receiving the TD-CSI feedback comprises: receiving the TD-CSI feedback in a CSI reporting window that occurs after a quantity of slots from a last CSI-RS occasion of the one or more CSI-RS occasions.

Aspect 41: The method of any of Aspects 25-40, wherein the first PDCCH communication comprises: downlink control information (DCI) that indicates a physical uplink control channel (PUSCH); and uplink data or another type of uplink control information other than the TD-CSI feedback.

Aspect 42: The method of any of Aspects 25-41, wherein the first PDCCH communication comprises downlink control information (DCI) that indicates a physical uplink control channel (PUSCH), and no uplink data or no other types of uplink control information.

Aspect 43: The method of any of Aspects 25-42, wherein the first PDCCH communication comprises downlink control information (DCI) that indicates a physical uplink control channel (PUSCH), and does not trigger additional CSI-RS occasions.

Aspect 44: The method of any of Aspects 25-43, wherein the second PDCCH communication comprises: downlink control information (DCI) that indicates an uplink grant for transmission of the TD-CSI feedback; and an additional field that indicates whether additional CSI-RS occasions are triggered.

Aspect 45: An apparatus for wireless communication at a device, comprising a processor; memory coupled with the processor; and instructions stored in the memory and executable by the processor to cause the apparatus to perform the method of one or more of Aspects 1-24.

Aspect 46: A device for wireless communication, comprising a memory and one or more processors coupled to the memory, the one or more processors configured to perform the method of one or more of Aspects 1-24.

Aspect 47: An apparatus for wireless communication, comprising at least one means for performing the method of one or more of Aspects 1-24.

Aspect 48: A non-transitory computer-readable medium storing code for wireless communication, the code comprising instructions executable by a processor to perform the method of one or more of Aspects 1-24.

Aspect 49: A non-transitory computer-readable medium storing a set of instructions for wireless communication, the set of instructions comprising one or more instructions that, when executed by one or more processors of a device, cause the device to perform the method of one or more of Aspects 1-24.

Aspect 50: An apparatus for wireless communication at a device, comprising a processor; memory coupled with the processor; and instructions stored in the memory and executable by the processor to cause the apparatus to perform the method of one or more of Aspects 25-44.

Aspect 51: A device for wireless communication, comprising a memory and one or more processors coupled to the memory, the one or more processors configured to perform the method of one or more of Aspects 25-44.

Aspect 52: An apparatus for wireless communication, comprising at least one means for performing the method of one or more of Aspects 25-44.

Aspect 53: A non-transitory computer-readable medium storing code for wireless communication, the code comprising instructions executable by a processor to perform the method of one or more of Aspects 25-44.

Aspect 54: A non-transitory computer-readable medium storing a set of instructions for wireless communication, the set of instructions comprising one or more instructions that, when executed by one or more processors of a device, cause the device to perform the method of one or more of Aspects 25-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE), comprising:
a memory; and
one or more processors, coupled to the memory, configured to:
receive a first physical downlink control channel (PDCCH) communication;
receive a second PDCCH communication after receiving the first PDCCH communication; and
transmit, based at least in part on receiving the second PDCCH, time-domain channel state information (TD-CSI) feedback for one or more associated CSI reference signal (CSI-RS) occasions.

2. The UE of claim 1, wherein the one or more processors are further configured to:
perform, based at least in part on receiving the first PDCCH communication, one or more measurements of the one or more CSI-RS occasions.

3. The UE of claim 2, wherein the TD-CSI feedback is based at least in part on results of the one or more measurements.

4. The UE of claim 1, wherein the one or more processors, to transmit the TD-CSI feedback, are configured to:
transmit the TD-CSI feedback in a second PUSCH communication after receiving the second PDCCH communication.

5. The UE of claim 1, wherein the first PDCCH communication comprises a first downlink control information (DCI) that indicates an uplink grant, or the second PDCCH communication comprises a second DCI that indicates an uplink grant for transmission of the TD-CSI feedback.

6. (canceled)

7. The UE of claim 1, wherein the first PDCCH communication and the second PDCCH communication include respective CSI request fields that both indicate a same CSI triggering state.

8. The UE of claim 7, wherein transmission of the TD-CSI feedback is after a quantity of symbols, from a CSI-RS occasion of the one or more CSI-RS occasions, that satisfies a symbol quantity threshold.

9. The UE of claim 8, wherein the one or more CSI-RS occasions are included in an aperiodic CSI-RS burst that is scheduled by the first PDCCH communication; and
wherein the CSI-RS occasion is a last CSI-RS occasion in the aperiodic CSI-RS burst that is scheduled by the first PDCCH communication.

10. The UE of claim 8, wherein the one or more CSI-RS occasions comprise a plurality of periodic or semi-persistent CSI-RS occasions that are associated with the TD-CSI feedback; and
wherein the CSI-RS occasion is a periodic or semi-persistent CSI-RS occasion, of the plurality of periodic or semi-persistent CSI-RS occasions, that occurs after a threshold quantity of periodic or semi-persistent CSI-RS occasions from first PDCCH communication.

11. The UE of claim 1, wherein the one or more processors, to transmit the TD-CSI feedback, are configured to:
transmit the TD-CSI feedback after a quantity of symbols, from the first PDCCH communication, that satisfies a symbol quantity threshold, or
transmit the TD-CSI feedback after a quantity of symbols, from the second PDCCH communication, that satisfies a symbol quantity threshold.

12. (canceled)

13. The UE of claim 1, wherein the one or more processors, to transmit the TD-CSI feedback, are configured to:
transmit the TD-CSI feedback prior to expiration of a timer that is initiated based at least in part on a last CSI-RS occasion of the one or more CSI-RS occasions, or
transmit the TD-CSI feedback prior to expiration of a timer that is initiated based at least in part on the first PDCCH communication.

14. The UE of claim 1, wherein the one or more processors, to transmit the TD-CSI feedback, are configured to:
determine a starting slot of a CSI window that occurs after a quantity of slots from a last CSI-RS occasion of the one or more CSI-RS occasions; and
determine a processing occupation duration, after reception of the first PDCCH communication and a starting slot of the CSI reporting window, for generating the TD-CSI feedback.

15. The UE of claim 1, wherein the one or more processors are further configured to at least one of:
determine a processing occupation duration, between reception of the first PDCCH communication and a last symbol of transmission of the TD-CSI feedback, for generating the TD-CSI feedback, or
determine a processing occupation duration, after reception of the first PDCCH communication and expiration of a TD-CSI feedback timer, for generating the TD-CSI feedback.

16. The UE of claim 1, wherein the first PDCCH communication comprises downlink control information (DCI) that indicates:
a physical uplink control channel (PUSCH) that is to include uplink data or another type of uplink control information other than the TD-CSI feedback.

17. The UE of claim 1, wherein the first PDCCH communication comprises downlink control information (DCI) that indicates:
an uplink control channel (UCI)-only physical uplink control channel (PUSCH) that is not to include uplink data nor other types of UCI other than the TD-CSI feedback.

18. (canceled)

19. The UE of claim 1, wherein the first PDCCH communication comprises downlink control information (DCI) that indicates:
an uplink control channel (UCI)-only physical uplink control channel (PUSCH) that is not to include uplink data nor other types of UCI other than the TD-CSI feedback; and
wherein the one or more processors are further configured to:
transmit the UCI-only PUSCH along with one or more arbitrary payloads based at least in part on the UCI-only PUSCH being scheduled to not include uplink data nor other types of UCI other than the TD-CSI feedback.

20. The UE of claim 1, wherein the second PDCCH communication comprises downlink control information (DCI) that indicates an uplink grant for transmission of the TD-CSI feedback, and does not trigger additional CSI-RS occasions.

21. The UE of claim 1, wherein the second PDCCH communication comprises:
downlink control information (DCI) that indicates an uplink grant for transmission of the TD-CSI feedback; and
an additional field that indicates whether additional CSI-RS occasions are triggered.

22. A network node, comprising:
a memory; and
one or more processors, coupled to the memory, configured to:
transmit a first physical downlink control channel (PDCCH) communication;
transmit a second PDCCH communication after transmitting the first PDCCH communication; and
receive, based at least in part on the second PDCCH, time-domain channel state information (TD-CSI) feedback for one or more CSI reference signal (CSI-RS) occasions.

23.-35. (canceled)

36. A method of wireless communication performed by a user equipment (UE), comprising:
receiving a first physical downlink control channel (PDCCH) communication;
receiving a second PDCCH communication after receiving the first PDCCH communication; and
transmitting, based at least in part on receiving the second PDCCH, time-domain channel state information (TD-CSI) feedback for one or more associated CSI reference signal (CSI-RS) occasions.

37.-38. (canceled)
